(19) United States
(12) Patent Application Publication
(10) Pub. No.: US 2025/0320144 A1
(43) Pub. Date: Oct. 16, 2025

(54) THERMAL TREATMENT OF FLUSH MANURE

(71) Applicant: SUSTAIN TECHNOLOGIES LLC, Charlotte, NC (US)

(72) Inventors: Robert Hickey, Okemos, MI (US); James M. Wallace, Charlotte, NC (US); Michael Hickey, Greenville, SC (US)

(21) Appl. No.: 18/633,442

(22) Filed: Apr. 11, 2024

(51) Int. Cl. C02F 9/00; C02F 1/00; C02F 1/02; C02F 1/38; C02F 3/28; C02F 11/04; C02F 103/20

(52) U.S. Cl. CPC C02F 9/00; C02F 2001/007; C02F 1/02; C02F 1/385; C02F 3/28; C02F 11/04; C02F 2103/20; C02F 2303/10

(57) ABSTRACT

A method that uses heat to economically recover usable flush water for livestock operation. The method thermally treats a dilute manure (DM) stream and separating the treated DM in a clarifier to produce output streams that pass to anaerobic digestion. This method minimizes the presence of biological activity and glycoprotein-based mucus that retards effective settling and removal of both sand and large sized TSS. Heating the DM thermally processes the input to the clarifier provides a net viscosity that promotes ready separation of both sand and TSS. The invention can be used in a closed loop flush water system or in recovering water usable for other purposes. Such other purposes include irrigation, recovery of clean water from the flush water using a UF membrane separation or aeration. Purification of such clean water can provide water for use in dairy operations.

### FIELD OF INVENTION

This invention relates to methods and processes for treating manure streams from animal husbandry and livestock operations. In further detail this invention relates to a method for the treatment of solids and the recovery of water from manure produced in livestock operation including dairy and swine operations, and more particularly, methods and processes for managing untreated or partially treated dairy manure or swine manure (SM) and for the treatment of such manure to recover solids, biogas and water.

### BACKGROUND OF THE INVENTION

The housing and confinement areas for ruminant animal farming operations and swine production generate dilute manure (DM) since it contains a high percentage of water. DM is also referred to as flush manure (FM) and can comprise manure from typical flush manure systems as well as from scrape and flume type operations.

The composition of manure varies based on the type of operations generating the manure. Two common sources of DM are cow manure and swine manure. Because of their diet the total suspended solids in swine manure contains very little fibrous material. Whereas manure from most ruminant animal operations, particularly cow manure from dairy operations, contains a significant quantity of fibrous material, such as straw, sawdust, or other bedding that becomes mixed with their excrement. Removal of the coarse fibrous material from manure such as cow manure produces a coarse screened manure (CSM) that contains liquid and solids and is essentially free of large fibrous material.

Typical treatment of DM breaks down suspended solids contained therein and produces a treated liquid with a reduced volume of solids; in addition, treatment usually includes the separation of solids from the treated liquid and separate recovery of liquid and solids. Advanced DM treatment methods use a wide variety of equipment and equipment arrangements to carry out these basic steps. These treatment methods require many process steps and ancillary equipment to tailor the method to specific composition of the DM and to obtain the desired outputs.

DM is recovered mainly from dairy and swine operations by the flushing of animal stalls, housing, and areas of confinement such as milk parlors for dairy cows. As detailed above the amount of fibers in DM varies with the animal in confinement and typically includes undigested and/or partially digested animal feed.

This invention may apply to DM recovered directly from animal housing, confinement operations, storage ponds and/or lagoons. For example, CSM and SM may enter a storage location in the form of a storage pond or lagoon. Lagoon storage operations may use a single lagoon or multiple lagoons, with SM operations typically using a single lagoon. Lagoons for other animal operations that produce CSM typically use multiple lagoons of an unmixed type. The lagoons promote settling and decomposition of organic matter. The lagoons also provide some degradation of the dissolved organics such that the effluent can be used for flushing.

A wide variety of equipment in a plurality of configurations have been used to recover valuable products from animal waste such as DM. Removal and conversion of the suspended solids, and the soluble organic compounds, purifies the water and concentrates the remaining solids. Purification removes most of the remaining solids from the liquid to provide recycle water, also known as water (FM), for reuse in the process.

It is known to add anaerobic digestion (AD) to the treatment and processing of DM. Most desirably AD provides the essential breakdown of soluble organics and suspended solids contained in FM with high COD removal efficiencies and low sludge production. Addition of anaerobic digestion AD can improve environmental stewardship, reduce odors, lower fugitive emissions, and provide biogas for sale or use on site, especially in the generation of electricity. In fact, recovering the methane gas produced by AD in manure processing operations to provide biogas for conversion to renewable natural gas (NRG) has received much recent attention. The digestate and the biogas may contain a variety of other chemical compounds such as ammonia compounds. Such compounds also regularly include sulfur compounds most prevalently as H2S. Treatment of the biogas by oxidation to remove H2S can provide a source of sulfuric acid.

Moreover, good water recovery is essential to effective DM treatment. Aside from recovery as flush water recovered water has many potential uses other than in a closed loop flush water system. Given any necessary additional treatments such uses include irrigation, animal cooling, and animal drinking water.

In particular, wastewater treatment using an anacrobic sequencing batch reactor (AnSBR) is known. U.S. Pat. No. 5,185,079 describes its basic design and operation and is herein incorporated by reference. In more detail U.S. Pat. No. 5,184,079A shows an anaerobic batch reactor with settlement of the biomass under quiescent condition and discloses that anaerobic digestion produces a digestate stream and a biogas. Biogas from anaerobic digestion is usually laden with CO₂ and purification of the biogas to usable methane, typically in the form of an RNG stream, also provides a gas stream rich in CO₂.

U.S. Pat. No. 9,656,895 B2 feeds an aqueous waste stream containing biodegradable material into an anaerobic bioreactor or AD that contains biomass and reacts the biodegradable material with the biomass to form methane. A portion of the bioreactor effluent passes to a membrane filtration unit that produces a retentate for return to the bioreactor. Another portion of the bioreactor effluent passes to one or more sludge treatment units that provide a treated sludge, a portion of which may pass to the bioreactor along with a flocculation or coagulation additive.

U.S. Pat. No. 10,781,143 B2 treats organic waste containing fibrous material by recovering coarse fibers that pass to a biogas digester and mechanically separates the effluent from the biogas digester into a concentrated fraction and a liquid fraction concentrate.

U.S. Pat. No. 7,5005,068 B2 describes a method for treating wastewater in which a clarifier receives an unheated input stream that passes to an AD.

Generating a clean stream for flushing in a closed loop system that effectively removes sand and reduces the total suspended solids (TSS) from DM via settling raises many difficulties. In general, dilution is the primary method used to help improve sand recovery and TSS settling (see A. Wedel, 2013). Practical considerations and costs of operating such processes along with the equipment costs limit amount of dilution that can be reasonably added to DM for recovery of flush water.

It is extremely important in the operation of closed loop water systems to remove sand and much of the TSS from the DM to produce water suitable for recycle as additional flush water. Those skilled in the art have attempted to recover suitable recycle water using settling, fine screening and/or centrifuging. Significant drawbacks attend the use of these methods. For example, the high viscosity of the glycoprotein based mucus in the DM impedes effective settling of sand and TSS. The difficulty in effecting such settling is shown by Chastain et. al., by its report that after flush manure, screened at 500 microns, was tested for total solids (TS) settling, only 15.6 and 18.1% of the TS (23.3% and ˜27% of the TSS, respectively) were removed at settling times of 30 and 60 minutes. In addition, fine screening comes at a high cost and requires multiple steps to achieve the effluent quality needed for reuse as flush water. Centrifugation works well but again adds capital cost for expensive equipment, significant operating cost, and dues to the abrasive nature of the sand high maintenance costs including repair/replacement of centrifuges.

Thus, a need exists to provide AD treatment of DM less expensive, more efficient, and more flexible. This will reduce costs and improve recovery of water for flush water and for other uses from DM. Reducing the cost and facilitating the utilization of advanced AD treatment will encourage its use to provide environmental benefits and profitability in the conversion and repurposing of the waste products in animal production and its operations.

### SUMMARY OF THE INVENTION

A method has now been found that can effectively and economically recover water that is usable as flush water for livestock operations by thermally treating a DM stream and separating the treated DM in a clarifier to produce output streams that pass to anaerobic digestion. It was recognized that simple settling will not remove suspended solids from the DM due to biological activity that causes the lighter TSS to float and that the viscous, glycoprotein-based mucus content of the DM retards effective settling and removal of both sand and large sized TSS. It was found that thermally processing the clarifier input by heating the DM reduces the DM's net viscosity into a range that promotes ready separation of both sand and TSS. Thus, this invention solves the problem of economically recovering flush water from DM for use in a closed loop flush water system or recovering water usable for other purposes. Such other purposes include irrigation, recovery of clean water from the flush water using a UF membrane separation or aeration. Purification of such clean water can provide water for use in dairy operations.

The instant invention uses heating of the DM to a point sufficient to denature the glycoproteins and pasteurize the manure contained therein. The heating subjects the DM to high temperatures for a short period of time, similar to the heating in high temperature short time (HTST) pasteurization of dairy products. The heat treatment conditions of this invention will usually bring the AD to a temperature of at least 65° C.

In a broad embodiment the invention is a process for the thermal treatment of DM streams. The inventive process comprises heating a DM stream to a temperature of at least 65° C. in a thermal treatment zone and producing a heated stream and passing the heated stream to a clarifier. A clarified effluent and a settled TSS stream comprising TSS are recovered from the clarifier. Following thermal treatment even relatively fine sand particles can be removed via steeling, hydrocyclones or similar separation techniques. At least a portion of the settled TSS stream passes to a high-solids AD that operates with a high solids loading and produces a first biogas stream and a first digestate comprising fibers. At least a portion of the clarified effluent and at least a portion of the first digestate pass to a short HRT AD that operates with a short HRT. The process produces a second biogas stream and a second digestate from the short HRT AD. The first and second digestate streams can provide a source of flush water and may undergo further processing to remove additional solids and improve the quality of the recovered water.

It is believed that glycoproteins comprise the main constituents of the mucous that raises the viscosity of the DM and that denaturing the glycoproteins with the heat treatment reduces the viscosity of the DM by a factor of 2 or more. For example, when going from 25° C. to 70° C. the kinetic viscosity changes from 0.8926 mm²/s to 0.4127 mm²/s. Furthermore, under the right conditions the denatured proteins can precipitate from the solution and act like a “sweep floc” that helps settle the finer TSS and thereby reducing the overall viscosity of the DM stream. In this way the heating step facilitates recovery of the TSS from the DM and enables the removal of sand and TSS via simple settling that generates a clean stream of flush water.

In another embodiment the invention is a process for the thermal treatment of DM streams that removes sand from the DM stream in a sand removal step and passes the DM stream from the sand removal step to at least one heat exchange step and then to a thermal treatment zone that heats the DM stream to a temperature of at least 65° C. to produce a heated stream. A clarifier separates the heated stream into a clarified effluent a settled TSS stream containing TSS. At least a portion of the settled TSS stream passes to a high-solids AD that operates with a solids concentration in a range of from 4% to 10% TS. The high-solids AD provides a first biogas stream and a first digestate. At least a portion of the clarified effluent passes to the heat exchange step that heats the DM. At least a portion of the clarified effluent and at least a portion of the first digestate passes to a short HRT AD that operates with a hydraulic retention time of from 1 to 5 days. The invention provides the right conditions for a thermal treatment that improves sand removal and TSS settling. The process also provides a second biogas stream and a second digestate from the short HRT AD.

In another embodiment the clarified effluent is sent to a heat exchanger to preheat the incoming DM and then the flow is split with a large portion recycled back to the barn as “clean” flush water and the remaining stream sent to an AD to produce biogas. In a variation of this embodiment at least a portion of the first digestate undergoes separation, typically using screening to produce a fiber effluent that also contains any remaining solids and to produce a screened digestate stream that usually passes at least in part to the short HRT AD. Further processing of the fiber effluent may produce a concentrated fiber stream. A further variation of this embodiment further treats all or a portion of the screened digestate to produce a cleaned water stream.

In another embodiment the invention is a process for the thermal treatment of DM streams that removes sand from the DM stream using a sand lane and a hydrocyclone and passes the DM stream from the sand removal to at least one heat exchange step. From the heat exchange step the DM enters a thermal treatment zone that heats the DM stream to a temperature of at least 65° C. for at least 30 seconds. The heated DM then goes to a clarifier after additional sand removal. The clarifier provides a clarified effluent and a settled TSS stream comprising TSS that passes to a high-solids AD in which the solids concentration ranges from 4% to 10% TS. The high-solids AD produces a first biogas stream and a first digestate. At least a portion of the clarified effluent passes to a heat exchanger that provides heat to the DM in at least one heat exchange step before it passes to the thermal treatment zone. At least a portion of the first digestate stream and/or the screened digestate stream pass to the short HRT AD. The short HRT AD operates with a hydraulic retention time of from 1 to 5 days. The process also provides a second biogas stream and a second digestate from the short HRT AD.

The invention also solves problems with other equipment operations. Calcium, magnesium, and/or phosphorous compounds, along with other compounds, can precipitate and coat and plug screens and other equipment. The higher temperature in the thermal treatment system reduces the solubility of certain compounds such as calcium and magnesium salts and promotes precipitation of calcium/magnesium carbonates and calcium/magnesium/phosphorus compounds thereby significantly reducing dissolved phosphorus, calcium, and magnesium concentrations in the clarified effluent. This reduces the chemical precipitation potential on the screens and other equipment as this reduced Ca/Mg/P containing flush water is recycled. The precipitated compounds will also have a specific gravity considerably greater than water, particularly at the elevated temperature, and so they may tend to act as coagulant aides improving overall TSS settling.

The invention also effectively pasteurizes the manure stream. Pasteurization provides safer recovered sand for use as bedding and reduced likelihood of infectious bacteria in flush water both of which will improve animal health.

The recovered TSS will have a high temperature and provides the option of digestion under thermophilic conditions to provide greater solids destruction and methane production.

Other aspects and advantages will become apparent upon consideration of the following detailed description and the attached drawings wherein like numerals designate like elements throughout the specification.

### BRIEF DESCRIPTION OF THE DRAWINGS

FIG. 1 is a flow diagram that schematically shows the basic process equipment for the practice of the invention.

FIG. 2 is a flow diagram that schematically shows the basic process of FIG. 1 with a variety of additional equipment and the interconnections thereof that may be used in the practice of the invention.

The figures schematically show the major equipment and process lines used in practicing this invention. The figures omit pumps, valves, instrumentation, control system etc. that are known by those designing and using the equipment for practicing the invention and are readily incorporated by those generally familiar with equipment, design, and operation of processes in the field of this invention.

### DETAILED DESCRIPTION

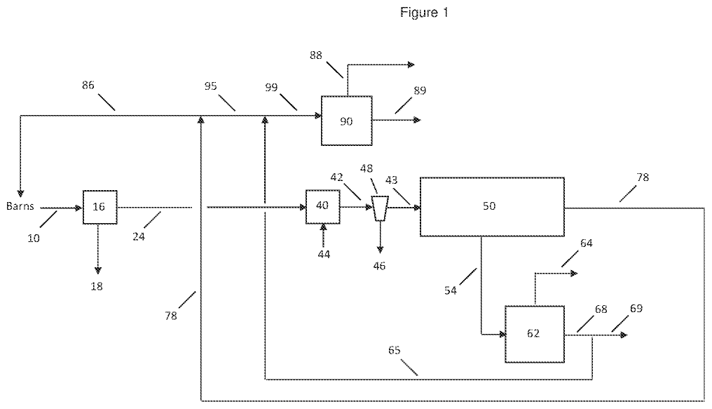

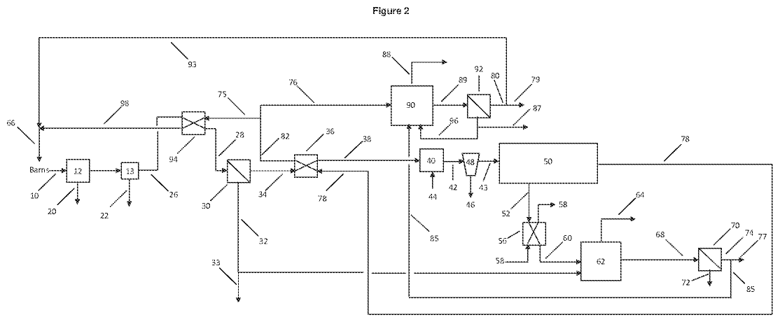

Referring to FIG. 1, the invention in its most basic form begins with a DM stream 24. from which at least a portion of the sand was removed. DM stream 24 will typically originate with a DM stream 10 emanating from barns or other animal confinement facilities that passes through a sand removal zone 16 designed to recover as much sand as possible. In this case the recovered sand exits the process via a and line 18. Sand removal zone 16 typically includes sand lanes, hydrocyclones, and similar equipment. Coarse fibers are known to inhibit good settling of the sand and TSS in later process steps. The DM stream 10, therefore, may also undergo initial screening to capture particles greater than ˜500 microns (as shown in FIG. 2)

As previously presented, the instant invention involves raising the temperature of flush manure to the point that proteins are denatured and the DM overall viscosity significantly reduced for a short period of time. Thermal treatment zone 40 pretreats the line of DM stream 24 by heating the DM to a treatment temperature of at least at least 65° C. for a hold time of at least 30 minutes. Other time and temperature combinations in zone 40 can provide the necessary thermal treatment. Such combinations typically use higher temperatures and shorter holding times. Suitable temperatures may range from 65° C. to 90° C. with holding times adjusted accordingly and usually in the range of 15 to 60 minutes. As previously explained, in addition to pasteurizing and denaturing the DM the thermal treatment zone 40 preferably provides a temperature and a time period that precipitates glycoproteins from the DM. Preferably, if possible, the process will use lower temperatures in thermal treatment zone 40 to reduce heat losses and lower heating costs.

Thermal treatment zone 40 receives the necessary heating from a heat source supplied by a line 44. Any source of heat including indirect heat exchange, steam injection or resistance heating, for example, may be used alone or in combination to heat the DM stream 24. A line 44 provides any necessary heat input or power input to supply the heat needed for the desired temperature in thermal treatment zone 40.

For purposes of maximizing heat conservation, DM stream 24 will typically receive heat by heat exchange with other process streams before entering thermal treatment zone 40. Any number of process streams downstream of the settling system may exchange heat with the DM stream 24 before it enters thermal treatment zone 40 (Sec FIG. 2).

Post thermal treatment, a settling system separates sand and settled TSS. In FIG. 1 a line 42 feeds the pretreated DM into a settling system that effects a settling of TSS from DM to provide a stream of settled TSS stream 54 containing TSS and a clarified effluent 78. The settling system usually provides two stages of settling that first removes sand and secondly settles a large fraction of the settleable TSS.

FIG. 1 a two-step process that employs a very short HRT separator 48 for settling sand followed by a longer HRT settling section in the form of a clarifier 50 designed to remove the settleable TSS. The longer settling section can simply employ gravity settling or settling may incorporate other structures.

In further detail of one possible arrangement the settling system of FIG. 1 is a two-stage setline system having a hydrocyclone 48 that receives the heated DM from line 42 that discharges fine sand via a line 46 and provides an output to a line 43 that passes the output of hydrocyclone 48 into clarifier 50. Clarifier 50 discharges the settled TSS in settled TSS stream 54 and the clarified effluent in line 78. The depiction of the settling system in the figures shows the functions of the settling system and not a required configuration of the settling system which may, for example, combine sand removal and settling into a unitary equipment configuration.

While not limiting other uses, the clarified effluent in line 78 will typically get recycled in the process and a portion of clarified effluent in line 78 will return to the barns as flush water via lines 78 and 86. Lines 95 and 99 pass another portion of clarified effluent in line 78 to an AD system that is typically in the form of a short HRT AD 90 that operates with a short HRT. Short HRT AD 90 produces a second biogas stream 88 and a digestate 89 that is generally sent to storage lagoons.

Settled TSS stream 54 may simply be dewatered and disposed of by thermal processing to generate biochar and syngas (not shown) but will more advantageously enter an AD system and preferably a high solids AD system 62 suited for the treatment of streams containing high solids. The high solids AD system 62 will generate a biogas stream 64 and a digestate stream 68. High solids AD system 62 can operate at thermophilic or mesophilic temperatures.

The process is not limited to any particular type of AD for short HRT AD 90 or high solids AD 62. Any AD suitable to effect the desired treatment may be used. Suitable types of AD include Anaerobic Filter (AF), Anaerobic Contact (AC), Upflow Anaerobic Contact (UAC), AnSBR or AnMBR process. Some process arrangements may employ anaerobic lagoons.

The digestate stream 68 can be used for a variety of purposes. It may get directly transferred to a storage lagoon via a line 69. A line 65 may pass a portion of the digestate stream 68 to short HRT AD 90 to provide active biological material to enhance digestion in short HRT AD 90. Other treatments and separations can provide aqueous streams suitable for irrigation and other water usage purposes.

The process may also recover ammonia. If either of the ADs operates thermophilically, the process may economically and advantageously incorporate ammonia removal from either of the digestates. However, if ammonia recovery is desired, the optimal place for an ammonia stripper would be on the clarified effluent before any heat exchange.

Turning to FIG. 2, practice of the process may use a variety of additional steps. Such steps include separation of solids, sand and output streams; recycle lines; and heat exchange. Thus, FIG. 2 shows a more detailed schematic embodiment of the process and some of the possibilities for process arrangements and the incorporation of additional steps. Where possible reference numbers between FIG. 1 and FIG. 2 identify the same items. Reference is made to FIG. 1 for any reference number identification not provided in conjunction with the description of FIG. 2.

Looking first at the additional separation steps shown in FIG. 2, DM stream 10 usually enters a sand removal zone that includes sand lanes 12, that reject sand via a line 20, and an additional separation stage 13. Additional separation stage 13 can include one or more hydrocyclones with removal of fine sand via line 22. Additional separation stage 13 provides a DM stream 26 with a reduced amount of sand. A separation stage 30 may receive DM stream 26 and line 28 to remove coarse fibers from the DM and provide a DM stream 34 and a stream of coarse solids carried by line 32. In some operations such as where coarse solids are wanted for other uses a line 33 may withdraw coarse solids from line 32. Where separation stage 30 is provided coarse fiber from line 32 and settled solids from line 52 may be blended to get the desired temperature for the operation of the high solids AD 62 without the need for cooling.

Digestate from high solids AD 62 will often undergo additional separation usually in the form of screening. This separation can provide a source of screened digestate to send to the short HRT AD if desired. FIG. 2 shows digestate stream 68 entering a screening section or separator 70 that yields screened digestate 74 and a residual effluent in line 72 that contains fibers. At least a portion of the screened digestate can be sent to short HRT AD 90 via line 85 with the residual wasted to lagoons via line 77.

The digestate 89 from the short HRT AD 90 may undergo solids separation/recovery in 92, which may be a UF or MF membrane that yields a clear permeate 80 that can provide an additional source of flush water that may be returned to the barns via lines 93 and 66 or may be used for other purposes as previously described such as sending it to storage lagoons via line 79. The membrane retentate may can be recovered and, at least in part, returned to short HRT AD 90 via line 96 to increase the active biomass solids retention time, thereby reducing the necessary HRT for 90. Line 87 can withdraw excess biomass from line 96 and send it to waste.

FIG. 2 shows line 72 that can recover coarse from screening device or separator 70. A portion of screened digestate 74 may be sent to short HRT AD 90 via line 85 to provide active biological material to enhance digestion in 90. Residual screened digestate is sent to lagoons or otherwise used via line 77.

With respect to recycling streams, FIG. 2 shows several lines in addition to those shown in FIG. 1. FIG. 2 shows just some of the possible lines for recycling various streams in the process. Multitudinous options exist for recycling residual effluent for flush water within the process of FIG. 2 that include both clarified DM 78 and/or permeate from short HRT AD 90 via line 93.

FIG. 2 also shows some of the heat exchange options that the process may include. FIG. 2 shows two locations for achieving heat recovery by transfer of heat to the DM. At one location a heat exchanger 36 transfers heat from clarified effluent in line 78 to DM that enters the exchanger 36 via line 34 and heated DM that exits via line 38 that provides the input to the thermal treatment zone 40. Some of the cooled, clarified effluent can exit heat exchanger 36 and enter heat exchanger 94 via lines 82 and 75 to initially heat to DM stream 26 that exits exchanger 94 as a DM stream carried by line 28. The now second cooled clarified effluent can pass back to the barns via lines 98 and 66.

Other arrangements of the process lines and heat exchangers can provide heat recovery. A line 76 that communicates with line 82 can transfer a portion of the cooled, clarified effluent to short HRT AD 90 in an arrangement where the clarified effluent bypasses exchanger 94. Alternately or in addition another line (not shown) may transfer the cooled clarified effluent from exchanger 94 to short HRT AD 90.

In addition to heating, the process may use heat exchange to provide cooling. The higher solids AD may benefit from a reduced temperature operation. FIG. 2 shows a heat exchanger 56 that withdraws heat from the settled TSS stream to cool the settled TSS that enters high solids AD 62 via line 60. Cooling flow shown as 58 can be from a number of sources where additional heating is beneficial. This arrangement is usually needed when coarse fibers are not removed by a separator, such as separator 30, since in this case the settled solids of line 52 will usually need to be cooled.

Although the instant invention is presented here as a process for treating flush manure in a closed loop type configuration, the technology's applications are much wider. For example, settling could be performed (such as in clarifier 50) and all or a part of the settled TSS sent to a high rate or moderate rate AD system to obtain water that when followed by further treatment can provide water for a dairy. Lagoons are another common destination for the effluents from AD systems such as clarified or screened digestate 74 and line 79. Water containing streams taken from lagoons can be used as irrigation water for growing crops and/or used as flush water. Again, it may be beneficial to further treat the effluent from a short HRT AD by aerobic treatment to again produce extremely clean water for reuse in the dairy.

In other variations screened water, such as that recovered as clarified digestate from separator 70 by line 77 or from separator 92 by line 79, may be further processed for nitrogen recovery and/or for irrigation by incorporating trace metal removal to prevent build-up of heavy metals in the soils. In addition, in an arrangement (not shown), residual effluent recoverable via lines 67 and 75 can, as previously described, receive further treatment using a UF membrane. Treating the residual effluent with a UF membrane enables production of a liquid effluent with essentially no suspended solids. The absence of suspended solids makes possible further treatment of such liquid effluents to capture ammonia and/or remove dissolved metals such as copper, zinc, lead and cadmium. Removing these dissolved metals allows land application of the liquid for crops and spraying fields at significantly reduced levels of metals build-up of metals. Settled solids recovered by line 72 or 67 may ultimately find use as a concentrated NPK product.

Those skilled in the art will appreciate that numerous modifications to the present disclosure and that the illustrated embodiments are exemplary only and should not be taken as limiting the scope of the disclosure.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar references in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein.

We claim:

1. A process for thermal treatment of dilute manure streams comprising:
a) heating a dilute manure stream to a temperature of at least 65° C. in a thermal treatment zone and producing a heated stream;
b) passing the heated stream to a clarifier and recovering from the clarifier a clarified effluent and a settled TSS stream comprising TSS;
c) passing at least a portion of the settled TSS stream to a high-solids anaerobic digester that operates with a high solids loading and recovering a first biogas stream and a first digestate from the high solids anaerobic digester;
d) passing at least a portion of the clarified effluent and at least a portion of the first digestate to a short HRT anaerobic digester that operates with a short HRT; and,
e) recovering from the short HRT anaerobic digester a second biogas stream and a second digestate.

2. The process of claim 1 wherein the dilute manure stream comprises flush manure and/or manure from scrape and flume type operations.

3. The process of claim 1 wherein sand is removed from the dilute manure and/or the heated stream.

4. The process of claim 3 wherein sand is removed from the dilute manure stream by a hydrocyclone.

5. The process of claim 1 wherein at least one heat exchanger heats the dilute manure with heat from the clarified effluent.

6. The process of claim 5 wherein sand is removed from the dilute manure with a hydroclone located downstream from at least one heat exchanger or downstream from the thermal treatment zone.

7. The process of claim 1 wherein the first digestate comprises coarse fibers and at least a portion of the coarse fibers are separated from at least a portion of the first digestate to produce a fiber effluent and a screened digestate stream.

8. The process of claim 1 wherein the dilute manure stream is heated to at least 65° C. for at least 30 minutes in the thermal treatment zone.

9. The process of claim 1 wherein the solids in the high solids anaerobic digester are in a range of from 4 to 10% total solids.

10. The process of claim 1 wherein the short HRT anaerobic digester has a hydraulic retention time of from 1 to 5 days.

11. The process of claim 1 wherein at least a portion of clarified effluent is used as flush water in livestock operations.

12. A process for thermal treatment of dilute manure streams comprising:
a) removing sand from the dilute manure stream in a sand removal step and passing the dilute manure stream from the sand removal step to at least one heat exchange step;
b) passing the dilute manure from the heat exchange step to a thermal treatment zone and heating the dilute manure stream to a temperature of at least 65° C. and producing a heated stream;
c) passing the heated stream to a clarifier and recovering from the clarifier a clarified effluent and a settled TSS stream comprising TSS;
d) passing at least a portion of the settled TSS stream to a high-solids anaerobic digester that operates with a solids concentration in a range of from 4 to 10% total solids and recovering from the high-solids anaerobic digester a first biogas stream and a first digestate;
e) passing at least a portion of the clarified effluent to the heat exchanger of step b) to supply heat to the dilute manure;
f) passing at least a portion of the clarified effluent and at least a portion of the first digestate to a short HRT anaerobic digester that operates with a hydraulic retention time of from 1 to 5 days; and,
g) recovering from the short HRT anaerobic digester a second biogas stream and a second digestate.

13. The process of claim 12 wherein sand is removed from the dilute manure by at least one of a sand removal lane and a hydroclone.

14. The process of claim 12 wherein sand is removed from the heated stream using a hydrocyclone.

15. The process of claim 12 wherein the first digestate comprises coarse fibers and coarse fibers are separated from at least a portion of the first digestate to recover a fiber effluent and a screened digestate stream.

16. The process of claim 15 wherein at least a portion of the first digestate or screened digestate stream is passed to the short HRT anaerobic digester.

17. The process of claim 12 wherein sand is removed from the dilute manure downstream from at least one heat exchange step.

18. The process of claim 12, wherein coarse fibers are separated from the dilute manure stream downstream of the at least one heat exchange step and at least a portion of the coarse fibers pass to the high solids AD.

19. A process for thermal treatment of dilute manure streams comprising:
a) removing sand from the dilute manure stream using a sand lane and a hydrocyclone;
b) passing the dilute manure stream from the sand removal of step a) to at least one heat exchange step;
c) passing the dilute manure from the heat exchange step to a thermal treatment zone and heating the dilute manure stream to a temperature of at least 65° C. for at least 30 minutes and producing a heated stream;
d) removing sand from the heated stream and passing the heated stream to a clarifier;
e) recovering from the clarifier a clarified effluent and a settled TSS stream comprising TSS;
f) passing at least a portion of the settled TSS stream to a high-solids anaerobic digester that operates with a solids concentration in a range of from 4 to 10% total solids;
g) recovering from the high-solids anaerobic digester a first biogas stream and a first digestate;
h) passing at least a portion of the clarified effluent to at least one of the heat exchange steps of step b) to heat the dilute manure;
i) separating coarse fibers from the first digestate to produce a fiber effluent and a screened digestate stream;
j) passing to a short HRT anaerobic digester at least a portion of the clarified effluent and at least a portion of the first digestate stream and/or the screened digestate stream and operating the short HRT anaerobic digester with a hydraulic retention time of from 1 to 5 days; and,
k) recovering from the short HRT anaerobic digester a second biogas stream and a second digestate.

20. The process of claim 19, wherein after the heat exchange of step h) a portion of the clarified effluent is used as flush water.
